(19) United States
(12) Patent Application Publication
(10) Pub. No.: US 2024/0041087 A1
(43) Pub. Date: Feb. 8, 2024

(54) METHODS AND PRODUCTS USING SWEET FLOUR FOR ENCAPSULATION

(71) Applicant: CORN PRODUCTS DEVELOPMENT, INC., WESTCHESTER, IL (US)

(72) Inventors: Katelyn MEYLER, Bridgewater, NJ (US); Matt HENLEY, Bridgewater, NJ (US); Afaf MAKARIOUS, Bridgewater, NJ (US)

(21) Appl. No.: 18/264,455

(22) PCT Filed: Mar. 1, 2022
(86) PCT No.: PCT/US2022/018247

§ 371 Date: Aug. 7, 2023

Related U.S. Application Data
(60) Provisional application No. 63/159,368, filed on Mar. 10, 2021.

(51) Int. Cl. A23P 10/47; A23L 29/10; A23L 29/219; A23P 10/30

(52) U.S. Cl. CPC A23P 10/47; A23L 29/10; A23L 29/219; A23P 10/30

(57) ABSTRACT

The technology disclosed in this specification pertains to encapsulating mixtures, encapsulating compositions, encapsulated products, and methods of their manufacture. The compositions and products comprise an emulsifier and a sweet flour and are useful for encapsulating oil-based ingredients. Such compositions and products can be formulated to have good oil retention and good oxidation resistance without the use of maltodextrins. In some embodiments the sweet flour is a sweet corn flour.

Disclosed in this specification are encapsulating compositions and encapsulated products using a sweet flour and methods for their manufacture. The products and compositions are useful for encapsulating or carrier ingredients for various uses such as delivering flavor oil-based ingredients for use in edible compositions, including beverages.

Commonly, especially beverages, flavoring or coloring ingredients are encapsulated or otherwise loaded on a carrier to form a powder. The powder is useful storage and delivery form and breaks down easily in the desired application to release ingredient. Encapsulated products are commonly made using oil-based ingredients which are encapsulated using a composition that stabilizes and protects an oil droplet within an oil-in-water emulsion, during spray drying to make a powder, and during storage in powder form. The emulsion stabilization and ingredient protection may be carried out by different ingredients in an encapsulation composition. The emulsion is stabilized by an emulsifier, often a modified starch, and ingredient protection is provided by a carrier. Maltodextrins have often been used as carriers because they can be used in relatively high amounts (which facilitates spray drying) without providing substantial viscosity to the emulsion (which would make spray drying harder) and they create a good barrier against oil loss from the encapsulation.

Within some market segments, however, maltodextrins are undesirable. A need exists, therefore, to find other carriers that provide the functionality of maltodextrins in encapsulated products. In at least one aspect, this specification discloses the use of sweet flour as a carrier in an encapsulation formulation to replace maltodextrins. In various aspects, this specification discloses encapsulation compositions and encapsulated products using sweet flour that have similar oil retention capability and low viscosity of maltodextrin encapsulated products. In other aspects, the disclosed encapsulated products can protect an encapsulated oil-based ingredient from oxidation equally to or better than encapsulated products using maltodextrin carriers. Other aspects and attributes of the technology disclosed are set forth in this specification.

The technology disclosed in this specification can be further understood with reference to the following figures, which are provided for illustrative purposes only and do not limit the full scope of the invention.

### BRIEF DESCRIPTION OF THE DRAWINGS

FIG. 1 compares oil droplet size distributions of embodiments of oil-in-water emulsions used to make encapsulated products.

Within this specification the term “sweet flour” means flour obtained from an endosperm of a cereal, grain or kernel comprising a recessive sugary-1 gene, which can be abbreviated Su-1 as the dominant allele, and su-1 as the recessive allele. Although not intended to be limiting as to a source for sweet flour, a useful source for sweet flour is sweet corn. A sugary-1 recessive corn, called within this specification a sweet corn, is available as the silver queen variant of corn. The sugary-1 gene is known and its role in the biosynthesis of starch has been studied by others. (See e.g. James, M. G., et al, “Characterization of the maize gene sugary 1, a determinant of starch composition in kernels,” Plant Cell vol. 7, pp. 417-429 (1995).) The following is provided to further describe sweet flours but is not intended to limit the full understanding of the effect of a recessive sugary-1 gene in the starch biosynthesis pathway. The recessive sugary-1 gene interferes with the normal synthesis of starch, which forms starch polymers having substantially more alpha-1-6 linkages between glycosides than is common in amylopectin or amylose. These abnormal starch polymers do not form granules (as is common of amylose and amylopectin) and they are soluble in water without the further processing typically required to solubilize starch in water: in other words they are soluble without prior gelatinization of the starch granule.

Sweet flour, and sweet corn flour, may be obtained by milling sweet grains or sweet corn kernels to obtain flour. Sweet flour, like other flours, contains (among other things) polysaccharides, fibers, lipids, proteins, and ash. Sweet flour differs from most flours, however, by naturally having a substantial amount of soluble starch. In any embodiment described in this specification, sweet flour, preferably a sweet corn flour, comprises from 75% to 85% by weight soluble starch. In any embodiment described in this specification, sweet flour comprises about 10% to about 30%, or about 13% to about 30%, or about 20% to about 30% granular starch (amylose and amylopectin) by weight of the flour. Granular starch and protein are generally insoluble without further processing.

In any embodiment described in this specification, a sweet flour may be clarified to remove at least some protein and granular starch. In the broadest sense a clarified sweet flour is any product having less protein than is found in a native sweet flour but enough residual protein to fall outside the commonly understood definition of starch in the food industry. For common corn starch or waxy corn starch this greater than about 0.5% protein by weight. For high amylose corn starch this greater than about 1.0% protein by weight. In preferred embodiments, however, a sweet flour or sweet corn flour are clarified to have protein content between about 2% and 9%. In any embodiment described in this specification, a sweet flour may be clarified by centrifugation as the insoluble components of the flour are separated from the soluble components, which remain in the supernatant and can be poured off the insoluble components, or otherwise separated from the insoluble component. In any embodiment described in this specification, sweet flour comprises greater than about 75%, or from about 80% to about 95% soluble starch. In any embodiment described in this specification, sweet flour comprises from about 80% to about 90% soluble starch by weight of the flour. In any embodiment described in this specification, sweet flour has sweet corn protein content in an amount greater than about 5% by weight of the flour. In any embodiment described in this specification, sweet flour has sweet corn protein content in an amount from about 5% to about 9% by weight of the flour. In any embodiment described in this specification a sweet flour has less insoluble starch content than sweet flour. In any embodiment a sweet flour has insoluble starch content of less than about 5% by weight of the flour.

In any embodiment a sweet flour is not high pressure filtered (using for example, microfiltration, ultrafiltration, or reverse osmosis filtration) to obtain a more uniform composition. In any embodiment described in this specification a sweet flour, or sweet corn flour described in this specification has a polydispersity index greater than 0.35, or greater than about 0.37, or from about 0.37 about 0.43. The polydispersity index (“PDI”) is a unitless measurement reflecting the heterogeneity, by size, of a set of particles. Within macroscopic systems, such as sweet flours described in this specification, the polydispersity index can be measured using dynamic light scattering.

In any embodiment a sweet flour or sweet corn has a mean particle size of from about 100 to about 200 nm or from about 100 to about 150 nm, or from about 120 to about 140 nm. In any embodiment the soluble starch in a sweet flour or sweet corn has a mean particle size of from about 100 to about 200 nm or from about 100 to about 150 nm, or from about 120 to about 140 nm. Polydispersity index and mean particle size can be measured in solutions of sweet flour by using dynamic light scattering.

In another aspect, the technology disclosed in this specification pertains to a spray dried product comprising a sweet flour and an active ingredient. In some embodiments the active ingredient may be an aqueous ingredient. In other embodiments an active ingredient may be a lipid-based, or fat-based, or oil-based ingredient. Within this specification active ingredient is used broadly and includes pharmaceutically active ingredients, or nutritional ingredients, or non-nutritive functional ingredients such as scents or flavors, and mixtures thereof. Active ingredients may be a single ingredient or may be combinations of ingredients. Spray dried products include agglomerated products and encapsulated products and mixtures thereof. In spray dried products and agglomerated products that are not encapsulated products a sweet flour may be mixed with other ingredients to carry an active ingredient and to provide enough bulk material to efficiently obtain a spray dried composition. For encapsulated products, a sweet flour is mixed with an emulsifier. The emulsifier stabilizes a water-oil interface to maintain small oil droplet size within an aqueous phase. During spray drying the sweet flour and optionally the emulsifier provide a coating around oil droplets to obtain an encapsulated active ingredient.

In another aspect the specification discloses mixture that can be mixed with an aqueous component to encapsulate an active ingredient. In any embodiment described in this specification, an encapsulating mixture comprises an emulsifier; and a sweet flour. In any embodiment of an encapsulating mixture described in this specification, the sweet flour is in an amount from about 50% to about 90% (wt. %) by of the composition or from about 50% to about 80% or from about 7% to about 80%. In any embodiment of an encapsulating mixture described in this specification the emulsifier is a modified starch. In any embodiment of an encapsulating mixture described in this specification the emulsifier is a succinate modified starch, or an octenylsuccinate modified starch. In any embodiment of an encapsulating mixture described in this specification the emulsifier is in an amount from about 10% to about 50% (wt. %) by weigh of the mixture, or from about 20% to about 40%, or from about 20% to about 30%.

In any embodiment of an encapsulating mixture described in this specification the sweet flour is sweet corn flour wherein the sweet corn flour comprises sweet corn protein in an amount greater than about 5% by weight of the flour, or from about 5% to about 9% by weight of the flour. In any embodiment of an encapsulating mixture described in this specification the mixture comprises protein from sweet flour in an amount of about 1.5% to about 9%, or from about 2% to about 9%, or from about 3% to about 9%, or from about 5% to about 9%.

In any embodiment of an encapsulating mixture described in this specification further comprises an antioxidant. In any embodiment of an encapsulating mixture described in this specification further comprises a glucose syrup wherein, optionally, the glucose syrup is in an amount from about 1% to about 30% (wt. %) by weight of the mixture or from about 10% to about 30, or from about 20% to about 30%. In any embodiment of an encapsulating mixture described in this specification wherein the composition does not include maltodextrin.

In any embodiment disclosed in this specification, an encapsulating composition is a composition that can be used to encapsulate an active ingredient. In any embodiment, an encapsulating composition, as described in this specification comprises an emulsifier and a sweet flour.

In any embodiment, this specification discloses an encapsulating composition wherein the emulsifier is a modified starch. In any embodiment, this specification discloses an encapsulating composition wherein the emulsifier is a succinate modified starch, for example an octenylsuccinate modified starch. In any embodiment, this specification discloses an encapsulating composition wherein the emulsifier in an amount from about 1% to about 10% by weigh of the composition. In any embodiment, this specification discloses an encapsulating composition wherein the emulsifier is in an amount from about 4% to about 8% by weight of the composition.

In any embodiment, this specification discloses an encapsulating composition wherein the sweet flour is in an amount of from about 10% to about 20% of the composition. In any embodiment, this specification discloses an encapsulating composition wherein the sweet flour is in an amount of from about 10% to about 14% of the composition. In any embodiment, this specification discloses an encapsulating composition wherein the sweet flour is in an amount of from about 16% to about 20% of the composition. In any embodiment, this specification discloses an encapsulation composition further comprising sweet corn protein (provided by the sweet flour) in an amount from about 0.5% to about 2.0% of the composition, or from about 0.5% to about 1.5%.

In any embodiment described in this specification, an encapsulating composition further comprises an antioxidant, which in at least some embodiments is a food grade antioxidant, and which in various embodiments is a glucose syrup. Other useful antioxidants include corn syrup, corn syrup solids, maltodextrin, glucose, maltose or any other carbohydrate with reducing power (ability to donate a hydrogen to quench free radicals). Still other useful antioxidants include phenolic compounds, carotenoids, chelating agents. Mixtures of one or more the forgoing antioxidants and types of antioxidants is also useful. In any embodiment described in this specification, an encapsulated product further comprises a glucose syrup.

In any embodiment described in this specification, an encapsulating composition further comprises a corn syrup or a glucose syrup in an amount from about 1% to about 10% by weight of the composition or from about 4% to about 8%. In any embodiment described in this specification, an encapsulating composition comprises an emulsifier, a sweet flour and enough glucose syrup to alter the dextrose equivalent value of the composition. In any embodiment described in this specification, an encapsulation composition comprises an emulsifier, comprising an emulsifying component and a sweet flour component, the emulsifier a having a dextrose equivalent of between about 5 and about 19. In any embodiment described in this specification, an encapsulation composition has a dextrose equivalent selected from the group consisting of a) about 6, or about 5 to about 7; b) about 12, or about 11 to about 13; and c) about 18, or about 17 to about 19. In any embodiment described in this specification, an encapsulation composition has a dextrose equivalent of about 18.

In any embodiment disclosed in this specification, an encapsulating composition is an aqueous dispersion comprising an emulsifier, a sweet flour and optionally an antioxidant. In any embodiment disclosed in this specification, an encapsulating composition is a dispersion comprising the water in an amount greater than 60% by weight of the composition, or from about 60% to about 80%.

In any embodiment described in this specification, an encapsulating composition further comprises an oil-based ingredient. In any embodiment described in this specification, an encapsulation composition further comprises an oil-based ingredient in an amount of greater than about 5% by weight of the composition, or greater than about 10% or from about 10% to about 25%. In any embodiment described in this specification, an encapsulating composition further comprises an oil-based ingredient in an amount from about 15% to about 25% by weight of the composition. In any embodiment described in this specification, an encapsulating composition further comprises an oil-based ingredient in an amount from about 18% to about 22% by weight of the composition. In any embodiment described in this specification an encapsulating composition is an emulsion comprising an aqueous dispersion comprising an emulsifier and a sweet flour (both as described elsewhere in this specification); and an oil-based ingredient described in this paragraph.

In any embodiment described in this specification, the encapsulating composition does not include maltodextrin.

Also described in this specification are encapsulated products resulting from spay drying emulsions described in this specification. In any embodiment, an encapsulated product comprises a sweet flour, an emulsifier, and oil and optionally an antioxidant. In any embodiment of an encapsulated product described in this specification the product further comprises a sweet corn protein in an amount greater than about 0.5% by weight of the encapsulated product, or in an amount from about 1% to about 9% by weight of the encapsulated product, of from about 1% to about 6% by weight of the encapsulated product. In any embodiment of an encapsulated product described in this specification the sweet flour is in an amount of from about 10% to about 25% by weight of the encapsulated product, or from about 10% to about 14% by weight of the encapsulated product, or from about 18% to about 24% by weight of the encapsulated product. In any embodiment of an encapsulated product described in this specification the oil is in an amount greater than about 5% by weight of the encapsulated product, or greater than about 10% or from about 10% to about 25%, or from about 10% to about 20% by weight of the encapsulated product, or from about 15% to about 25% of the encapsulated product. In any embodiment of an encapsulated product described in this specification the emulsifier is in an amount of from about 1 to about 10% by weight of the encapsulated product, or from about 4% to about 8% by weight of the encapsulated product.

In any embodiment, a method of making an encapsulated product comprises obtaining an emulsion having a mean droplet size selected from the group consisting of less than about 2.5 microns; less than about 1.5 microns, and from about 0.5 microns to about 1.5 microns. Emulsions (as described in this specification) having a defined drop size are made by mixing a mixture of oil-based ingredient and an aqueous dispersion using one or more mixing speeds from between about 1,000 and about 10,000 rpm using any commonly available mixing equipment. In at least one embodiment an emulsion having a defined droplet size is made in a two-step emulsification process wherein first a crude emulsion is made by mixing oil-based ingredient and aqueous solution at a first speed and second a homogenized emulsion is made by further mixing the crude emulsion at a second higher speed (both the first and second speeds being with the range of from 1,000 to 10,000 rpm). In any embodiment disclosed in this specification, a first speed used to make a crude emulsion is from about 4000 to about 6000 rpm. In any embodiment disclosed in this specification, a second speed used to homogenize an emulsion is from about 6000 and about 8000 rpm.

In any embodiment, a method of making an encapsulated product comprises spray drying an emulsion of oil-based ingredient and an aqueous solution to have a desired particle size. In any embodiment, an encapsulated product is spray dried using convention spray drying equipment to have a particle size generally on the order of less than about 100 microns. In any embodiment, an encapsulated product is spray dried to have a mean particle size from about 25 microns to about 75 microns.

In another aspect this specification discloses encapsulate products comprising an emulsifier and sweet flour, and oil-based ingredient and optionally a reducing agent, which may preferably be a glucose syrup. All said ingredients have the attributes and are used amounts described in this specification. Encapsulated products as described in this specification have a particle size generally on the order of less than 100 microns, and in various embodiments have a mean particle size of from 25 to 75 microns. In any embodiment described in this specification, an encapsulated product has a content oil-based ingredient in an amount greater than about 5% by weight of the product, or greater than about 10% or from about 10% to about 25%. In any embodiment described in this specification, an encapsulated product has oil-based ingredient in an amount from about 10% to about 20% by weight of the product. In any embodiment an encapsulation product has oil-based ingredient in an amount from about 13% to about 18%.

Encapsulated products or other end products have emulsifier and sweet flour content (by weigh) that is in line with the descried embodiments of encapsulating composition but accounting for carried or encapsulated ingredient. Additionally they will have emulsifier and sweet four content (by weight) that is in line with embodiments of the described embodiments emulsion but accounting for the substantial elimination of moisture.

In another aspect this specification discloses use of encapsulated product in an edible composition, preferable a beverage. In another aspect this specification discloses a method of making an edible composition, preferably a beverage comprising mixing an encapsulated product and a second ingredient.

A second ingredient is any second ingredient useful in an edible composition. Useful second ingredients include starch including but not limited to corn starch, tapioca starch, pea starch, fava bean starch, lentil starch, chickpea starch, tapioca starch, potato starch, sago starch, and mixtures thereof, as well as high amylose and low amylose variants of such starches. Such starches also may be within flours and meals including wheat flour, tapioca flour, rice flour, and corn meal. Useful starches may be modified or unmodified. Modified starches may be crosslinked including by using phosphate or adipate, or may be stabilized, including hydroxypropylation and acetylation. Useful starch may be converted or hydrolyzed using shear, enzyme, acid, or oxidation. Starch may also be modified usefully by oxidation for purposes other than hydrolysis. Useful starch may be physically modified such as by thermal inhibition, annealing, or heat moisture treatments. Modified and unmodified starch may be pregelatinized or otherwise made cold water soluble.

Second ingredients include sweeteners such as dextrose, allulose, tagatose, fructose, glycerol, sucrose, erythritol, rebaudiosides (A, B, J, M, etc.), and glucosylated stevia glycosides, and corn syrups including high fructose corn syrups. Sweeteners may be provided in solid, or powdered, or liquid, or syrup form.

Second ingredients also include gums, including gums and gum like materials and include gelling starches, gum Arabic, xanthan gum, tara gum, konjac, carrageenan, locust bean gum, gellan gum, guar gum, and mixtures thereof.

Second ingredients also include fats (other than vegetable oils) included animal fats and dairy fats. Useful aqueous ingredients include water, milk, syrups, or other carbohydrate containing liquids, or acidic liquids, or basic liquids.

Second ingredients also include various other flavorings, seasonings and colorings.

The following definitions may be useful in understanding the technology disclosed in this specification.

Within this specification the term “dextrose equivalent” (and abbreviate as “DE”) measures the amount of reducing sugars present in a sugar product, expressed as a percentage on a dry basis relative to dextrose. For example, a product having a dextrose equivalent value 10 (or “DE 10”) has about 10% of the reducing power of dextrose. The dextrose equivalent also gives an indication of the average degree of polymerization (DP) for starch sugars. Dextrose equivalent is a well understood term in the art, and the provided definition is for illustrative purposes only and is not intended to limit the full understanding of the term. Dextrose equivalent can be measured by method known in the art.

Within this specification the term “sweet flour” means flour obtained from an endosperm of a cereal, grain or kernel comprising a recessive sugary-1 gene, which can be abbreviated Su-1 as the dominant allele, and su-1 as the recessive allele. Although not intended to be limiting as to a source for sweet flour, a useful source for sweet flour is sweet corn. A sugary-1 recessive corn, called within this specification a sweet corn, is available as the silver queen variant of corn. The sugary-1 gene is known and its role in the biosynthesis of starch has been studied by others. (See e.g. James, M. G., et al, “Characterization of the maize gene sugary 1, a determinant of starch composition in kernels,” Plant Cell vol. 7, pp. 417-429 (1995).) The following is provided to further describe sweet flours but is not intended to limit the full understanding of the effect of a recessive sugary-1 gene in the starch biosynthesis pathway. The recessive sugary-1 gene interferes with the normal synthesis of starch. With reference to sweet corn, a significant portion of the starch in sweet corn kernel (sometimes greater 65%) chemical structure having substantially more alpha-1-6 linkages between glycosides, which is more than is common in amylopectin or amylose. These abnormal starch polymers do not form granules (as is common of amylose and amylopectin) and they are soluble in water without the further processing typically required to solubilize starch in water: in other words they are soluble without prior gelatinization of the starch granule.

Within this specification, “clarified sweet flour” refers to a sweet flour that has been processed to remove at least some of the protein and insoluble starch from the composition. Clarified sweet flour is a subset of sweet flour and reference to sweet flour includes clarified sweet flour unless clear from the context to be limited to one of clarified sweet flour or sweet flour. Similarly, sweet corn flour includes clarified sweet corn flour unless limited by context. All embodiments in this specification made using sweet flour or sweet corn flour may also be made using clarified sweet flour or clarified sweet corn flour.

Within this specification, “soluble starch” refers to starch that is soluble without having be subjected to a process using heat and moisture to disrupt the granular structure of starch (called gelatinization). Soluble starch, as used in this specification is starch that is soluble and is obtained from the endosperm of a cereal, grain, or kernel (including for example but not limited to a sweet corn kernel) having a recessive sugary-1 gene. Soluble starch has substantially more alpha-1-6 linkages between glycosides than is common in amylopectin or amylose. The increased alpha 1-6 linkages of soluble starch make soluble starch distinguishable from gelatinized amylose or amylopectin starch: gelatinized amylose and amylopectin are not within the definition of “soluble starch” as that term is use in this specification. In comparison, insoluble starch refers to starch that requires gelatinization before it will dissolve in an aqueous solution, or to starch that does not dissolve in an aqueous solution at all.

Within this specification, the term “glucose syrup” includes a class of products marketed as glucose syrups (or confectioner's glucose or corn syrups) and similar products. Commonly, glucose syrups result from the hydrolysis of starch (frequently, but not necessarily, corn starch) to form syrups comprising short chain polysaccharides. Depending on their grade, glucose syrups can have from 10% to at least about 90% glucose. Glucose syrups can be sold based on their dextrose equivalent value, and DE 42 and DE 63 glucose syrups are commonly available commercial grades. The various embodiments described in this specification are not limited to use of a type or grade of glucose syrup. Additionally, all glucose syrups have measurable solids content. At least some embodiments in this specification describe glucose syrup as a dry product. Although the remaining moisture of the glucose syrup is removed to dry the product, the primarily short chain polysaccharides from the glucose syrup remain in the final dried product. The primarily short chain polysaccharides of glucose syrup can be distinguished from other polysaccharides (mostly starch) and proteins in sweet flour using high performance liquid chromatography based at least on molecular weight (and/or difference in degree of polymerization) and are included in the meaning of “glucose syrup” within this specification.

Use of “about” to modify a number is meant to include the number recited plus or minus 10%. Where legally permissible recitation of a value in a claim means about the value. Use of about in a claim or in the specification is not intended to limit the full scope of covered equivalents.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology disclosed in this specification can be further understood by reference to the following aspects which are provided for illustrative purposes and are not intended to limit the full scope of the invention.
1. An encapsulating mixture comprising: an emulsifier; and a sweet flour.
2. Encapsulating mixture of claim 1 wherein the sweet flour is in an amount from about 50% to about 90% (wt. %) by of the composition or from about 50% to about 80% or from about 70% to about 80%.
3. The encapsulating mixture of claim 1 or 2, wherein the emulsifier is a modified starch.
4. The encapsulating mixture of any one of claims 1 to 3 wherein the emulsifier is a succinate modified starch, or an octenylsuccinate modified starch.
5. The encapsulating mixture of any one of claims 1 to 4 wherein the emulsifier is in an amount from about 10% to about 50% (wt. %) by weigh of the composition, or from about 20% to about 40%, or from about 20% to about 30%.
6. The encapsulating mixture of any one of claims 1 to 5 wherein the sweet flour is sweet corn flour and further comprises sweet corn protein in an amount greater than about 5% by weight of the flour, or from about 5% to about 9% by weight of the flour by weight of the flour.
7. The encapsulating mixture of any one of claims 1 to 6 wherein composition comprises from about 1.5% to about 9%, or from about 2% to about 9%, or from about 3% to about 9%, or from about 5% to about 9%.
8. The encapsulating mixture of any one of claims 1 to 7 further comprising an antioxidant.
9. The encapsulating mixture of any one of claims 1 to 8 further comprising a glucose syrup wherein, optionally, the glucose syrup is in an amount from about 1% to about 30% (wt. %) by weight of the composition or from about 10% to about 30, or from about 20% to about 30%
10. The encapsulating composition of any one of claims 1 to 9 wherein the composition does not include maltodextrin.
11. An encapsulating composition comprising the encapsulating mixture of any one of the foregoing claims and an aqueous component, wherein, optionally, the aqueous component is in an amount greater than 60% by weight of the composition, or from about 60% to about 80%.
12. The encapsulating composition of claim 11, wherein the emulsifier is a modified starch.
13. The encapsulating composition of claim 11 or 12 wherein the emulsifier is a succinate modified starch, or an octenylsuccinate modified starch.
14. The encapsulating composition of any one of claims 11 to 13 wherein the emulsifier is in an amount from about 1% to about 10% by weigh of the composition, or from about 4% to about 8% by weight of the composition.
15. The encapsulating composition of any one of claims 11 to 14 wherein the sweet flour is sweet corn flour and further comprises sweet corn protein in an amount greater than about 5% by weight of the flour, or from about 5% to about 9% by weight of the flour by weight of the flour.
16. The encapsulating composition of any one of claims 11 to 15 wherein the sweet flour is in an amount of from about 10% to about 20% of the composition or in an amount from about 10% to about 14% by weight of the composition, or from about 16% to about 20% by weight of the composition.
17. The encapsulating composition of any one of claims 11 to 16 further comprising an antioxidant.
18. The encapsulating composition of any one of claims 11 to 17 further comprising a glucose syrup wherein, optionally, the glucose syrup is in an amount from about 1% to about 10% by weight of the composition or from about 4% to about 8%.
19. The encapsulating composition of any one of claims 11 to 18 further comprising sweet corn protein in an amount from about 0.5% to about 2.0% of the composition, or from about 0.5% to about 1.5%.
20. The encapsulating composition of any one of claims 11 to 19 wherein the composition is an aqueous dispersion.
21. The encapsulating composition of any one of claims 11 to 20 wherein the composition does not include maltodextrin.
22. The encapsulating composition of any one of claims 11 to 21 having a dextrose equivalent of between about 5 and about 19, wherein optionally, the dextrose equivalent is between about 5 to about 7; or between about 11 to about 13; or between about 17 to about 19.
23. The encapsulating composition of any one of claims 11 to 22 having a dextrose equivalent of about 18.
24. The encapsulating composition of any one of claims 11 to 23 wherein the sweet flour has a polydispersity index greater than 0.35, or greater than about 0.37, or from about 0.37 about 0.43.
25. The encapsulating composition of any one of claims 11 to 24 wherein the sweet flour is selected from the group consisting of clarified sweet flour, sweet corn flour, and clarified sweet corn flour, and wherein, preferably, the sweet flour is clarified sweet corn flour.
26. An emulsion comprising: a) an aqueous dispersion comprising an emulsifier and a sweet flour; and b) an oil-based ingredient in an amount greater than about 5% by weight of the emulsion, or greater than about 10%, or from about 10% to about 25%, or from about 15% to about 25% by weight of the emulsion.
27. The emulsion of claim 26 wherein the oil-based ingredient is in an amount from about 18% to about 22% by weight of the emulsion.
28. The emulsion of claim 26 or 27 wherein the emulsifier is a modified starch.
29. The emulsion of any one of claims 26 to 28 wherein the emulsifier is a succinate modified starch or an octenylsuccinate modified starch.
30. The emulsion of any one of claims 26 to 29 wherein the emulsifier is in an amount from about 1% to about 10% by weight of the emulsion, or from about 4% to about 8% by weight of the emulsion.
31. The emulsion of any one of claims 26 to 30 further comprising sweet corn protein in an amount from about 0.5% to about 2.0% of the emulsion, or from about 0.5% to about 1.5%.
32. The emulsion of any one of claims 26 to 31 wherein the sweet flour is in an amount of from about 10% to about 20% or from about 10% to about 14% of the emulsion; or from about 16% to about 20% of the emulsion.
33. The emulsion of any one of claims 26 to 32 further comprising an antioxidant.
34. The emulsion of any one of claims 26 to 33 further comprising a glucose syrup wherein, optionally, the glucose syrup is in an amount from about 1% to about 10% by weight of the emulsion or from about 4% to about 8%.
35. The emulsion of any one of claims 26 to 34 having water in an amount greater than about 60% by weight of the emulsion, or from about 60% to about 80%.
36. The emulsion of any one of claims 26 to 35 wherein the emulsion does not include maltodextrin.
37. The emulsion of any one of claims 26 to 36 having a dextrose equivalent of between about 5 and about 19, or between about 5 to about 7, or between about 11 to about 13, or between about 17 to about 19.
38. The emulsion of any one of claims 26 to 37 having a dextrose equivalent of about 18.

39. The emulsion of any one of claims 26 to 38 wherein the sweet flour is selected from the group consisting of clarified sweet flour, sweet corn flour, and clarified sweet corn flour, and wherein, preferably, the sweet flour is clarified sweet corn flour.

40. A product comprising: an active ingredient a sweet flour.
41. The product of claim 40 wherein the product is spray dried.
42. The product of claim 40 or 41 wherein the active ingredient and sweet flour are an agglomerated product.
43. The product of any one of claims 41 to 42 wherein the active ingredient is encapsulated at least in part by the sweet flour.
44. The product of any one of claims 41 to 43 wherein the active ingredient is an aqueous ingredient.
45. The product of any one of claims 41 to 44 wherein the active ingredient is an oil-based ingredient, and wherein, optionally, the oil-based ingredient is used in an amount of greater than about 5% by weight of the product, or greater than about 10% or from about 10% to about 25%.
46. The product of any one of claims 41 to 45 wherein the wherein the sweet flour is selected from the group consisting of clarified sweet flour, sweet corn flour, and clarified sweet corn flour, and wherein most preferably the sweet flour is clarified sweet corn flour.
47. The product of any one of claims 41 to 46 wherein the product the sweet flour is sweet corn flour and wherein product further comprises a sweet corn protein in an amount greater than about 0.5% by weight of the product or in an amount from about 1% to about 9% by weight of the product, or from about 1% to about 6% by weight of the product.
48 An encapsulated product comprising: an emulsifier; a sweet flour; and an oil in an amount greater than about 5% by weight of the encapsulated product, or greater than about 10% or from about 10% to about 25%, or from about 10% to about 20% by weight of the encapsulated product, or from about 15% to about 25% of the encapsulated product.
49. The encapsulated product of claim 48 wherein the emulsifier is a modified starch.
50. The encapsulated product of claim 48 or 49 wherein the emulsifier is a succinate modified starch or an octenylsuccinate modified starch.
51. The encapsulated product of any one of claims 48 to 50 wherein the emulsifier is in an amount of from about 1 to about 10% by weight of the encapsulated product, or from about 4% to about 8% by weight of the encapsulated product.
52. The encapsulated product of any one of claims 48 to 51 wherein the sweet flour is sweet corn flour and wherein the product further comprises a sweet corn protein in an amount greater than about 0.5% by weight of the encapsulated product, or in an amount from about 1% to about 9% by weight of the encapsulated product, of from about 1% to about 6% by weight of the encapsulated product.
53. The encapsulated product of any one of claims 48 to 52 wherein the sweet flour is in an amount of from about 10% to about 25% by weight of the encapsulated product, or from about 10% to about 14% by weight of the encapsulated product, or from about 18% to about 24% by weight of the encapsulated product.
54. The encapsulated product of any one of claims 48 to 53 further comprising an antioxidant, wherein, optionally, the antioxidant is a glucose syrup.
55. The encapsulated product of any one of claims 48 to 54 further comprising a glucose syrup wherein, optionally, the glucose syrup is in an amount from about 1% to about 10% by weight of the encapsulated product, or from about 4% to about 8%.
56. The encapsulated product of any one of claims 48 to 55 wherein the product is a powder, and wherein, optionally, the encapsulated product is made by spray drying the emulsion.
57. The encapsulated product of any one of claims 48 to 56 wherein the encapsulated product does not contain maltodextrin.
58. The encapsulated product of any one of claims 48 to 57 wherein the sweet flour is selected from the group consisting of clarified sweet flour, sweet corn flour, and clarified sweet corn flour, and wherein most preferably the sweet flour is clarified sweet corn flour.
59. A method of making a composition comprising: mixing a sweet flour and an active ingredient to form a mixture; and spray drying the mixture.
60. The method of claim 59 wherein the active ingredient is an aqueous ingredient.
61. The method of claim 59 or 60 wherein the active ingredient is an oil-based ingredient, and wherein, optionally the oil-based ingredient is used in an amount of greater than about 5% by weight of the product, or greater than about 10%, or from about 10% to about 25% by weight of the product.
62. A method of making an encapsulated product comprising: mixing an emulsifier, a sweet flour, and water or an aqueous solution to obtain an encapsulation composition; mixing an oil-based ingredient with the encapsulation composition to form an emulsion; and spray drying the emulsion to obtain the encapsulated product.
63. The method of claim 62 wherein the emulsion is emulsified to have a mean droplet size of less than about 2.5 microns, or less than about 1.5 microns, or from about 0.5 microns to about 1.5 microns.
64 The method of claim 62 or 63 wherein the emulsifier is a modified starch.
65. The method of any one of claims 62 to 64 wherein the emulsifier is a succinate modified starch or an octenylsuccinate modified starch.
66. The method of any one of claims 62 to 65 wherein the emulsifier is in an amount from about 1% to about 10% by weight of the encapsulation composition, or from about 4% to about 8% by weight of the encapsulation composition.
67. The method of any one of claims 62 to 66 wherein the sweet flour further comprises sweet corn protein in an amount greater than about 5% by weight of the sweet flour or from about 5% to about 9% by weight of the sweet flour by weight of the sweet flour.
68. The method of any one of claims 62 to 67 wherein the sweet flour is a sweet corn flour and the encapsulation composition further comprises from about 0.5% to about 2.0% sweet corn protein by weight, or from about 0.5 to about 1.5%, and wherein the sweet corn protein is provided by the emulsion.
69. The method of any one of claims 62 to 68 wherein the sweet flour is in an amount of from about 10% to about 20% of the encapsulation composition, or from about 10% to about 14% of the encapsulation composition, or from about 16% to about 20% of the encapsulation composition.
70. The method of any one of claims 62 to 69 further comprising mixing an antioxidant in step a) to form the encapsulation composition.
71. The method of any one of claims 62 to 70 further comprising mixing a glucose syrup in step a) to form the encapsulation composition wherein, optionally, the glucose syrup is in an amount from about 1% to about 10% by weight of the encapsulation composition or from about 4% to about 8%.
72. The method of one of claims 62 to 71 wherein encapsulation composition has water in an amount greater than 60% by weight of the encapsulation composition, or from about 60% to about 80%.
73. The method of any one of claims 62 to 72 wherein the encapsulation composition has a dextrose equivalent of between about 5 and about 19 or between about 5 to about 7, or between about 11 to about 13, or between about 17 to about 19, or about 18.
74. The method of any one of claims 62 to 73 wherein the oil-based ingredient is in an amount greater than about 5% by weight of the product, or greater than about 10%, or from about 10% to about 25%, or from about 15% to about 25% by weight of the product.
75. The method of any one of claims 62 to 74 further comprising an oil-based ingredient in an amount from about 18% to about 22%.
76. The method of any one of claims 62 to 75 wherein the method does not include the addition of maltodextrin.
77. The method of any one of claims 62 to 76 wherein the sweet flour has a polydispersity index greater than 0.35, or greater than about 0.37, or from about 0.37 about 0.43.
78. The method of any one of claims 62 to 77 wherein the sweet flour is selected from the group consisting of clarified sweet flour, sweet corn flour and clarified sweet corn flour, wherein most preferably the sweet flour is a clarified sweet corn flour.
79. Use of the encapsulated product as described in any forgoing claim in an edible composition.
80. The use of the encapsulated product as recited in claim 79 to flavor a beverage.
81. A method of making an edible composition comprising adding an encapsulated product as described in any of the foregoing claims with a second edible ingredient.
82. The method of claim 82 wherein the edible composition is a beverage.
83. Use of a sweet flour to replace maltodextrin in an encapsulating composition or an encapsulated product as described in any foregoing claim.
84. Use of a sweet flour as recited in claim 83 wherein the sweet flour is a sweet corn flour and comprises a sweet corn protein in an amount greater than about 5% by weight of the flour, or from about 5% to about 9% by weight of the flour by weight of the flour.
85. Use of a sweet flour as recited in claim 83 or 84 wherein the sweet flour is in an amount of from about 10% to about 20% of the composition, in an amount selected from the group consisting of about 10% to about 14% of the composition, and about 16% to about 20% of the composition.
86. The use of a sweet flour as recited in any one of claim 83 or 85 and having a polydispersity index greater than 0.35, or greater than about 0.37, or from about 0.37 about 0.43.
87. Use as recited in any one of claim 84 or 86 where the sweet flour is selected from the group consisting of clarified sweet flour, sweet corn flour and clarified sweet corn flour, wherein most preferably the sweet flour is a clarified sweet corn flour.
88. A clarified sweet flour comprising: a soluble starch in an amount greater than about 75%, or from about 80% to about 95% by weight of the flour, or about 80% to about 90%.
89. The sweet flour of claim 88 and having a polydispersity index greater than about 0.35, or greater than about 0.37, or from about 0.37 to about 0.43.
90. The clarified sweet flour of claim 88 or 89 having a protein content in an amount greater than about 0.5% protein, or greater than about 1.0% protein or, preferably, selected from the group consisting of a) greater than about 2% by weight of the flour, b) from about 2% to about 4%, and c) from about 5% to about 9% by weight of the flour.
91. The clarified sweet flour of any one of claims 88 to 90 having an insoluble starch content of less than about 5% by weight of the flour.
92. The clarified sweet flour of any one of claims 88 to 91 having a mean particle size of a particle size distribution of from about 100 to about 200 nm, or from about 100 to about 150 nm, or from about 120 to about 140 nm.
93. The clarified sweet flour of any one of claims 88 to 92 being a sweet corn flour.
95 A mixture comprising: a) an emulsifier; and b) sweet flour; wherein, optionally, the sweet flour is a sweet corn flour or a clarified sweet corn flour.
96. The mixture of claim 95 wherein the sweet flour is in an amount from about 50% to about 90% (wt. %) by of the composition or from about 50% to about 80% or from about 70% to about 80%.
97. The mixture of claim 95 or 96, wherein the emulsifier is a modified starch wherein, optionally the emulsifier is a succinate modified starch, or an octenylsuccinate modified starch.
98. The mixture of any one of claims 95 to 97 wherein the emulsifier is in an amount from about 10% to about 50% (wt. %) by weigh of the composition, or from about 20% to about 40%, or from about 20% to about 30%.
99. The mixture of any one of claims 95 to 98 wherein composition comprises sweet corn protein in an amount from about 1.5% (wt. %) to about 9%, or from about 2% to about 9%, or from about 3% to about 9%, or from about 5% to about 9%.
100. The mixture of any one of claims 95 to 99 further comprising an antioxidant.
101. The mixture of any one of claims 95 to 100 further comprising a glucose syrup wherein, optionally, the glucose syrup is in an amount from about 1% to about 30% (wt. %) by weight of the composition or from about 10% to about 30, or from about 20% to about 30%.
102. The composition of any one of claims 95 to 101 wherein the composition does not include maltodextrin.
103. An emulsion comprising: a) an aqueous dispersion comprising water, an emulsifier, and a sweet flour; and b) an oil-based ingredient in an amount greater than about 5% by weight of the emulsion, or greater than about 10%, or from about 10% to about 25%, or from about 15% to about 25% by weight of the emulsion wherein, optionally, the sweet flour is in an amount of from about 10% to about 20% or from about 10% to about 14% of the emulsion; or from about 16% to about 20% of the emulsion wherein, optionally the sweet flour is a sweet corn flour or a clarified sweet corn flour.
104. The emulsion of claim 103 wherein the oil-based ingredient is in an amount from about 18% to about 22% by weight of the emulsion.
105. The emulsion of claim 103 or 104 wherein the emulsifier is a modified starch wherein the emulsifier is a succinate modified starch or an octenylsuccinate modified starch wherein, optionally, the emulsifier is in an amount from about 1% to about 10% by weight of the emulsion, or from about 4% to about 8% by weight of the emulsion.
106. The emulsion of any one of claims 103 to 105 further comprising sweet corn protein in an amount from about 0.5% to about 2.0% of the emulsion, or from about 0.5% to about 1.5%.
107. The emulsion of any one of claims 103 to 106 further comprising an antioxidant wherein, optionally the antioxidant is a glucose syrup wherein, optionally, the glucose syrup is in an amount from about 1% to about 10% by weight of the emulsion or from about 4% to about 8% wherein, optionally, the glucose syrup is in an amount such that the emulsion has a dextrose equivalent of between about 5 and about 19, or between about 5 to about 7, or between about 11 to about 13, or between about 17 to about 19, or about 18 wherein, optionally, the emulsion does not include maltodextrin.
108. The emulsion of any one of claims 103 to 106 having water in an amount greater than about 60% by weight of the emulsion, or from about 60% to about 80%.
109. A product comprising: a) an active ingredient b) a sweet flour wherein, optionally, the sweet flour is a sweet corn flour or a clarified sweet corn flour
110. The product of claim 109 wherein the product is spray dried.
111. The product of claim 109 or 110 wherein the active ingredient is an aqueous ingredient.
112. The product of any one of claims 109 to 111 wherein the active ingredient and sweet flour are an agglomerated product.
113. The product of any one of claims 109 to 112 wherein the active ingredient is an oil-based ingredient, and wherein, optionally, the oil-based ingredient is used in an amount of greater than about 5% by weight of the product, or greater than about 10% or from about 10% to about 25%.
114. The product of any one of claims 109 to 113 wherein the active ingredient is encapsulated at least in part by the sweet flour.
115. The product of claim 109 being an encapsulated product further comprising: a) an emulsifier; and c) an oil in an amount greater than about 5% by weight of the encapsulated product, or greater than about 10% or from about 10% to about 25%, or from about 10% to about 20% by weight of the encapsulated product, or from about 15% to about 25% of the encapsulated product wherein, optionally, the sweet flour is in an amount of from about 10% to about 25% by weight of the encapsulated product, or from about 10% to about 14% by weight of the encapsulated product, or from about 18% to about 24% by weight of the encapsulated product.
116 The product of claim 115 wherein the emulsifier is a modified starch wherein, optionally, the emulsifier is a succinate modified starch or an octenylsuccinate modified starch wherein, optionally, the emulsifier is in an amount of from about 1 to about 10% by weight of the encapsulated product, or from about 4% to about 8% by weight of the encapsulated product.
117. The product of any one of claims 109 to 116 further comprising an antioxidant, wherein, optionally, the antioxidant is a glucose syrup wherein, optionally, the glucose syrup is in an amount from about 1% to about 10% by weight of the encapsulated product, or from about 4% to about 8%.
118. The encapsulated product of any one of claims 109 to 117 wherein the encapsulated product does not comprise maltodextrin.
119. A method of making a composition comprising: a) mixing a sweet flour and an active ingredient to form a mixture; and b) and spray drying the mixture wherein, optionally, the sweet flour is a sweet corn flour or a clarified sweet corn flour.
120. The method of claims 119 wherein the active ingredient is an aqueous ingredient.
121. The method of claim 119 or 120 wherein the active ingredient is an oil-based ingredient wherein the mixing further mixing comprises an emulsifier and water or an aqueous solution with the sweet flour and active ingredient wherein, optionally, the oil-based ingredient, is used in an amount of greater than about 5% by weight of the product, or greater than about 10%, or from about 10% to about 25% by weight of the product wherein, optionally, the sweet flour is in an amount of from about 10% to about 20% of the encapsulation composition, or from about 10% to about 14% of the encapsulation composition, or from about 16% to about 20% of the encapsulation composition.
122. The method of claim 121 wherein the emulsion is emulsified to have a mean droplet size of less than about 2.5 microns, or less than about 1.5 microns, or from about 0.5 microns to about 1.5 microns.
123. The method of claim 120 or 121 wherein the emulsifier is a modified starch wherein, optionally, the emulsifier is a succinate modified starch or an octenylsuccinate modified starch. wherein, optionally, the emulsifier is in an amount from about 1% to about 10% by weight of the encapsulation composition, or from about 4% to about 8% by weight of the encapsulation composition.
124. The method of any one of claims 119 to 123 further comprising mixing an antioxidant in step a) to form the encapsulation composition wherein, optionally, the antioxidant is a glucose syrup wherein, optionally, the glucose syrup is in an amount from about 1% to about 10% by weight of the encapsulation composition or from about 4% to about 8% wherein, optionally, glucose syrup is in an amount such that the encapsulation composition has a dextrose equivalent of between about 5 and about 19 or between about 5 to about 7, or between about 11 to about 13, or between about 17 to about 19, or about 18.
125. The method of any one of claims 119 to 124 wherein the method does not include adding a maltodextrin.
126. Use of the encapsulated product as described in any forgoing claim in an edible composition.
127. Use of the encapsulated product as recited in claim 126 to flavor a beverage.
128. Use of a sweet flour to replace maltodextrin in an encapsulating composition or an encapsulated product as described in any foregoing claim wherein, optionally, the sweet flour is a sweet corn flour or a clarified sweet corn flour.
129. A clarified sweet flour comprising: a soluble starch in an amount greater than about 75% or from about 80% to about 95% by weight of the flour, or about 80% to about 90%.
130. The sweet flour of claim 129 and having a polydispersity index greater than about 0.35, or greater than about 0.37, or from about 0.37 to about 0.43.
131. The clarified sweet flour of claim 129 or 130 having a protein content in an amount greater than about 0.5% protein, or greater than about 1.0% protein or, preferably, selected from the group consisting of a) greater than about 2% by weight of the flour, b) from about 2% to about 4%, and c) from about 5% to about 9% by weight of the flour.
132. The clarified sweet flour of any one of claims 129 to 131 having an insoluble starch content of less than about 5% by weight of the flour.
133. The clarified sweet flour of any one of claims 129 to 132 having a mean particle size of a particle size distribution of from about 100 to about 200 nm, or from about 100 to about 150 nm, or from about 120 to about 140 nm.
134. The clarified sweet flour of any one of claims 129 to 133 being a sweet corn flour.
135. A clarified sweet flour comprising: a soluble starch in an amount greater than about 75% or from about 80% to about 95% by weight of the flour, or about 80% to about 90% wherein, optionally, the clarified sweet flour further comprising a protein in an amount greater than about 0.5% protein, or greater than about 1.0% protein or, preferably, selected from the group consisting of a) greater than about 2% by weight of the flour, b) from about 2% to about 4% by weight of the flour wherein, optionally, the sweet flour has an insoluble starch content of less than about 5% by weight of the flour wherein, optionally the clarified sweet flour is a sweet corn flour.
36 The sweet flour of claim 135 and having a polydispersity index greater than about 0.35, or greater than about 0.37, or from about 0.37 to about 0.43 wherein, optionally, the clarified sweet flour has a mean particle size of a particle size distribution of from about 100 to about 200 nm, or from about 100 to about 150 nm, or from about 120 to about 140 nm.

The technology disclose in this specification can be further understood with reference to the following Examples, which are provided for illustrative purposes only and are not intended to limit the full scope of the invention.

### EXAMPLE 1—METHOD FOR MAKING ENCAPSULATED PRODUCTS USING SWEET CORN FLOUR

The efficacy of sweet corn flour (“SCF”) as a carrier for flavor encapsulation formulations was compared against an 18-dextrose equivalent maltodextrin (“DE18 MD”). Formulations were made to encapsulate flavored oil. The encapsulation formulations included an OSA-modified starch as an emulsifier and in some embodiments included glucose syrup, dextrose equivalent 62 and 82% solids, as an antioxidant. In samples containing sweet corn flour and glucose syrup, corn syrup was added in an amount to obtain an approximate dextrose equivalent of 18 for the mixture of sweet corn flour and glucose syrup. The samples were designed to provide about 20% oil load within the spray dried encapsulated product. All samples were evaluated for oil retention and for oxidation resistance. Formulas for encapsulation formulations are reported in Table 1.

TABLE 1
Encapsulation Formulation

| | | Formulation | | | | |
|---|---|---|---|---|---|---|
| | | | | | Glucose | Flavored |
| | Carrier | Water | Emulsifier | Carrier | Syrup | Oil |
| Batch | used | (wt. %) | (wt. %) | (wt. %) | (wt. %) | (wt. %) |
| 1 | DE18 MD | 70 | 6 | 18 | 0 | 6 |
| 2 | SCF | 70 | 6 | 18 | 0 | 6 |
| 3 | SCF | 70 | 6 | 12 | 6 | 6 |
| 4 | SCF | 63 | 6 | 18 | 6 | 7 |

Encapsulated products were made as follows. Emulsifier (OSA-starch), carrier, and optionally glucose syrup, were mixed with water until dispersed or dissolved to form an encapsulating composition. The flavored oil was then added to the encapsulating composition to form an oil-in-water emulsion having encapsulated oil droplets. The emulsion was formed in two steps, first mixing at 5000 RPM for two minutes to form a crude emulsion, and then for three minutes at 7000 RPM to homogenize the crude emulsion. The sizes of the encapsulated oil droplets s are reported in Table 2. Measurements were made by using a laser diffraction particle size analyzer (Beckman Coulter). Table 2 reports the droplet size, in microns of various measurements. The D90 reports the maximum size of the droplets in the 90^{th} percentile of the droplet size distribution (90% of the measured droplets were equal to or smaller than the measured size). Similarly the D50 reports the maximum size of droplets in the 50^{th} percentile (50% of the measured droplets were equal to or smaller than the measured size), and D10 reports the size of droplets in the 10^{th} percentile (10% of the measured droplets were equal to or smaller than the measured size). Measurements are as reported by the laser diffraction particle size analyzer according to an analyzed diameter. Table 2 also reports the mean and mode particle size measured for the droplets in the batch.

TABLE 2
Encapsulated Oil Droplet Size (diameter)

| | | | | Mean | Mode |
|---|---|---|---|---|---|
| | | | | droplet | droplet |
| | D90 | D50 | D10 | size | size |
| Batch | (microns) | (microns) | (micron) | (microns) | (microns) |
| 1 | 2.548 | 1.596 | 0.848 | 1.641 | 1.748 |
| 2 | 1.928 | 0.885 | 0.338 | 1.020 | 1.451 |
| 3 | 2.294 | 1.302 | 0.407 | 1.335 | 1.592 |
| 4 | 1.745 | 0.880 | 0.368 | 0.975 | 1.321 |

The size distribution profiles for the encapsulated oil droplets are shown in FIG. 2. Notably in all cases the droplet size of the samples made with sweet corn flour (Batches 2-4) are generally smaller than samples made with maltodextrin (Batch 1), showing that sweet corn flour formed good emulsions with small droplet size, and showing that sweet corn flour can sufficiently stabilize an emulsion to allow the emulsion to form an encapsulated product upon spray drying. It is also seen that the amounts of sweet corn flour (comprising soluble starch) and corn syrup (antioxidant) can be modified to provide a formulation with a droplet size distribution closer to that of the maltodextrin sample (see Batch 1 versus Batch 3).

Homogenous emulsions from Table 1 were spray dried under the following conditions: 140°−180° C. inlet temperature, 85°−90° C. outlet temperature with a target particle size of 50 microns. The particle size of the treated samples was measured using a Malvern particle size analyzer, and results are reported Table 3. Table 3 reports the D90, D50, and D10 of the particle size distribution of the encapsulated particles, as well as the mode particle size of the particles.

TABLE 3
Size of Encapsulated Particles (diameter)

| | D90 | D50 | D10 | | Mode |
|---|---|---|---|---|---|
| Batch | (microns) | (microns) | (microns) | Mean | (microns) |
| 1 | 37.767 | 19.774 | 10.321 | Not calculated | 19.930 |
| 2 | 47.733 | 23.138 | 11.404 | Not calculated | 22.650 |
| 3 | 40.098 | 19.763 | 10.430 | Not calculated | 19.930 |
| 4 | 57.684 | 26.254 | 12.563 | Not calculated | 25.730 |

All encapsulated products were spray dried to control for particle size distribution, and all spray dried samples were measured and found to have similar particle size distributions. Batches were stored in glass vials to await functional analysis. Samples were either stored at freezing temperatures (about −18° C., considered fresh samples) until analyzed or incubated at 50° C. for 14-day for aging studies.

### EXAMPLE 2—EFFICACY OF SWEET CORN FLOUR AS A CARRIER IN ENCAPSULATING FORMULATIONS

Four encapsulated products were tested for oil retention (oil as wt. % of fresh encapsulated products—i.e. the amount of oil retained during the encapsulation process) and oxidation stability (i.e. increase in orange oil oxidation products over time). Oil retention measurements (of fresh samples from freezer) are presented in Table 2 and is expressed as the weight percentage of oil relative to the weight of the encapsulated product. Oil in the encapsulated product was measured by disruption of the encapsulation by water. Acetone was then added to precipitate the encapsulating material. The amount of flavored oil was then quantified using gas chromatography/mass spectrometry (GC/MS) selected ion monitoring (SIM). A Stabilwax-DA column (30 m×0.25 mm×0.2511 m) was used as stationary phase and helium was the choice of carrier gas. The oil levels were quantified using an internal calibration method with ethyl benzoate as the internal standard.

TABLE 4
Oil In Encapsulated Product

| | Oil |
|---|---|
| Batch | (wt. % of encapsulated product) |
| 1 | 15.9 |
| 2 | 15.9 |
| 3 | 15.2 |
| 4 | 16.3 |

The oxidation stability of the encapsulated formulations is reported in Table 4. Oxidation stability measures the increase of volatile oxidation products from the encapsulation. The results are reported in parts per million. The total volatile oxidation products were measured for fresh samples of encapsulated product and samples of encapsulated product stored for two weeks at a temperature of 50° C. (aged samples).

Oxidation products were measured using gas chromatography/mass spectrometry (GC/MS) selected ion monitoring (SIM). A Stabilwax-DA column (30 m×0.25 mm×0.2511 m) was used as stationary phase and helium was the choice of carrier gas. Oil in the encapsulated product was measured by disruption of the encapsulation by water. Acetone was then added to precipitate the encapsulating material. The target oxidation products were limonene oxide, carvone and carveol. The orange oil oxidation product levels were then quantified using an internal calibration method with ethyl benzoate as the internal standard.

TABLE 5
Oxidation Stability Results

| | | Aged (two weeks' |
|---|---|---|
| | Fresh | storage at 50° C.) |
| | (oxidation products | (oxidation products |
| Batch | ppm) | ppm) |
| 1 | 537 | 10,400 |
| 2 | 488 | 19,000 |
| 3 | 488 | 6140 |
| 4 | 496 | 5410 |

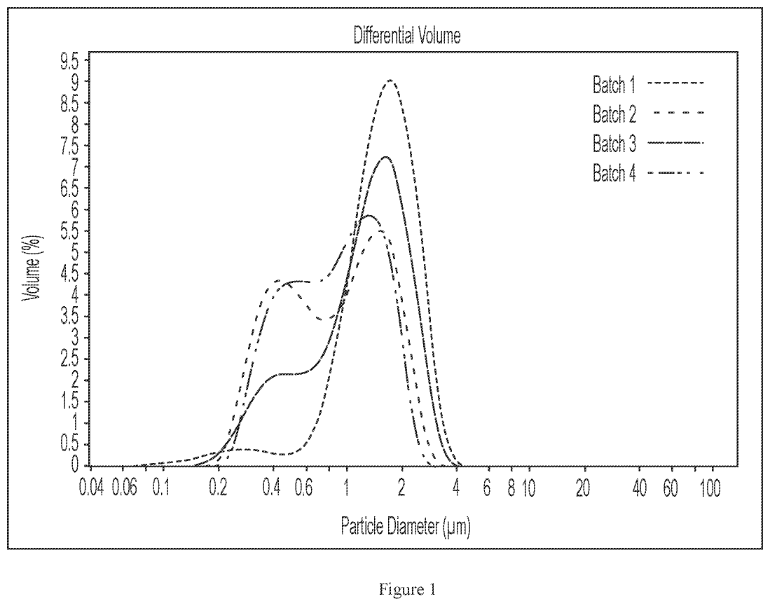

As seen from FIG. 1, and Tables 3-5, all samples had similar percent oil retention, similar amounts of oxidation products in fresh samples, and similar particle size distributions. Also, as seen Batches 3 and 4, using sweet corn flour and glucose syrup provided the highest stability against oxidation suggesting that they would have improved shelf life compare to samples using maltodextrin or that use no antioxidant.

1. A mixture comprising:
a. an emulsifier; and
b. a sweet flour;
wherein, optionally, the sweet flour is a sweet corn flour or a clarified sweet corn flour.

2. The mixture of claim 1 wherein the sweet flour is in an amount from about 50% to about 90% (wt. %).

3. The mixture of claim 1, wherein the emulsifier
is a succinate modified starch, or an octenylsuccinate modified starch.

4. The mixture of claim 1 wherein the emulsifier is in an amount from about 10% to about 50% (wt. %).

5. (canceled)

6. The mixture of claim 1 further comprising an antioxidant.

7. (canceled)

8. The mixture of claim 1 wherein the composition does not include maltodextrin.

9. A product comprising:
a. an active ingredient
b. a sweet flour
wherein, optionally, the sweet flour is a sweet corn flour or a clarified sweet corn flour.

10. The product of claim 9 wherein the product is spray dried.

11. The product of claim 9 wherein the active ingredient is an aqueous ingredient.

12. (canceled)

13. The product of claim 9 wherein the active ingredient is an oil-based ingredient, and

14. The product of claim 9 wherein the active ingredient is encapsulated at least in part by the sweet flour.

15. The product of claim 9 being an encapsulated product and further comprising:
a. an emulsifier; and
b. an oil in an amount greater than about 5% by weight of the encapsulated product.
wherein, the sweet flour is in an amount of from about 10% to about 25% by weight of the encapsulated product.

16. (canceled)

17. The product of claim 9 further comprising an antioxidant.

18. The product of claim 9 wherein the product does not comprise maltodextrin.

19. A method of making a composition comprising:
a. mixing a sweet flour and an active ingredient to form a mixture; and
b. and spray drying the mixture
wherein, optionally, the sweet flour is a sweet corn flour or a clarified sweet corn flour.

20. (canceled)

21. (canceled)

22. The method of claim 19 wherein the mixing step further mixing the sweet flour and active ingredient with an emulsifier so that the mixing step forms an emulsion having a mean droplet size of less than about 2.5 microns.

23. (canceled)

24. The method of claim 19 wherein the mixing step further comprises mixing the sweet flour and active ingredient with
a glucose syrup to obtain an encapsulation composition having a dextrose equivalent of between about 5 and about 19 wherein the encapsulation composition is the mixture resulting from the step a).

25. The method of claim 19 wherein the method does not include adding a maltodextrin.

26. (canceled)

27. (canceled)

28. (canceled)

29. A clarified sweet corn flour comprising: a soluble starch in an amount of greater than about 85%
wherein, the clarified sweet corn flour further comprises a sweet corn protein in an amount greater than about 0.5% protein
wherein, the sweet flour has an insoluble starch content of less than about 5% by weight of the flour.

30. The sweet flour of claim 29 and having a polydispersity index greater than about 0.35.
